(19) United States
(12) Patent Application Publication
(10) Pub. No.: US 2021/0337202 A1
(43) Pub. Date: Oct. 28, 2021

(54) ADAPTIVE QUANTIZATION METHOD FOR 360-DEGREE VIDEO CODING

(71) Applicant: VID SCALE, INC., Wilmington, DE (US)

(72) Inventors: Xiaoyu Xiu, San Diego, CA (US); Yuwen He, San Diego, CA (US); Yan Ye, San Diego, CA (US)

(73) Assignee: VID SCALE, INC., Wilmington, DE (US)

(21) Appl. No.: 16/625,144

(22) PCT Filed: Jun. 21, 2018
(86) PCT No.: PCT/US2018/038757

§ 371 Date: Dec. 20, 2019

Related U.S. Application Data
(60) Provisional application No. 62/522,976, filed on Jun. 21, 2017.

(51) Int. Cl. H04N 19/124; H04N 19/186; H04N 19/176; H04N 19/167

(52) U.S. Cl. CPC H04N 19/124; H04N 19/167; H04N 19/176; H04N 19/186

(57) ABSTRACT

Systems, procedures, and instrumentalities may be provided for adaptively adjusting quantization parameters (QPs) for 360-degree video coding. For example, a first luma QP for a first region may be identified. Based on the first luma QP, a first chroma QP for the first region may be determined. A QP offset for a second region may be identified. A second luma QP for the second region may be determined based on the first luma QP and/or the QP offset for the second region. A second chroma QP of the second region may be determined based on the first chroma QP and/or the QP offset for the second region. An inverse quantization may be performed for the second region based on the second luma QP for the second region and/or the second chroma QP for the second region. The QP offset may be adapted based on a spherical sampling density.

### CROSS-REFERENCE

This application claims the benefit of U.S. Provisional Application No. 62/522,976, filed on Jun. 21, 2017, which is incorporated herein by reference as if fully set forth.

### BACKGROUND

Virtual reality (VR) is increasingly entering our daily lives. VR has many application areas, including healthcare, education, social networking, industry design/training, game, movie, shopping, entertainment, etc. VR is gaining attention from industries and consumers because VR may bring an immersive viewing experience. VR creates a virtual environment surrounding the viewer and generates a true sense of “being there” for the viewer. How to provide the full real feeling in the VR environment is important for a user's experience. For example, the VR system may support interactions through posture, gesture, eye gaze, voice, etc. To allow the user to interact with objects in the VR world in a natural way, the VR may provide haptic feedback to the user.

### SUMMARY

Adaptive quantization may be performed in 360-degree video coding. 360-degree video content described herein may include or may be a spherical video content, an omnidirectional video content, a virtual reality (VR) video content, a panorama video content, an immersive video content (e.g., a light field video content that includes 6 degree of freedom), a point cloud video content, and/or the like.

Luma quantization parameter (QP) adjustment and chroma QP adjustment may be performed on a coding region basis based on the projection geometry. For example, QP may be adjusted on a coding unit level (e.g., block level). A QP offset for the current block may be calculated based on the spherical sampling density of the current block.

For example, the luma QP associated with an anchor region may be identified. Based on the luma QP, the chroma QP associated with the anchor region may be determined. For example, the luma QP for the anchor region may be parsed from the bitstream, and the chroma QP for the anchor region may be calculated based on the parsed luma QP. A QP offset associated with a current region may be identified. The luma QP of the current region may be determined, for example, based on the luma QP for the anchor region and the QP offset for the current region. The chroma QP of the current region may be determined based on the chroma QP for the anchor region and the QP offset for the current region. An inverse quantization may be performed for the current region based on the luma QP and the chroma QP of the current region.

An anchor region may include or may be an anchor coding block. The anchor region may be a slice or a picture associated with the current coding block. The luma QP and/or the chroma QP may be determined at a coding unit level or a coding tree unit level. The QP offset may be identified based on a QP offset indication in a bitstream. The QP offset may be calculated or determined for the current coding region (e.g., the current block, the current slice, the current coding unit, the current coding tree unit, or the like) based on its spherical sampling density. The QP offset may be calculated or determined for the current coding region based on a comparison of the spherical sampling density of the current coding region and the spherical sampling density of the anchor region. The QP offset may be calculated based on the location (e.g., the coordinate(s)) of the current coding region.

The adjustments for luma QP and for chroma QP may be decoupled. The QP offset for adjusting the luma QP and the QP offset for adjusting the chroma QP may be different. The chroma QP(s) and the luma QP may be independently adjusted. A QP offset for the current coding region may be calculated. The luma QP may be adjusted based on calculated QP offset (e.g., by applying the QP offset for the current coding region to the luma QP of the anchor region). The calculated QP offset may be weighted before being applied to adjust the chroma QP.

The chroma QP may be determined based on the QP offset that has been weighted by a weighting factor. The weighting factor may be signaled in the bitstream. The chroma QP may be adjusted using a weighted QP offset. The weighted QP offset may be generated by applying a weighting factor to the QP offset for the current region. The chroma QP may be determined by applying the weighted QP offset to the chroma QP of the anchor region. Inverse quantization may be performed based on the independently adjusted luma and chroma QPs.

### BRIEF DESCRIPTION OF THE DRAWINGS

A more detailed understanding may be had from the following description, given by way of example in conjunction with the accompanying drawings wherein:

FIGS. 1A, 1B, 1C show example sphere geometry projections to a 2D plane with equirectangular projection (ERP).

FIGS. 2A, 2B, 2C show cubemap projection (CMP) examples.

FIG. 3 shows an example workflow of a 360-degree video system.

FIG. 4 shows an example diagram of a block-based video encoder.

FIG. 5 shows an example block diagram of video decoder.

FIG. 6A shows example comparisons between a chroma quantization parameter (QP) adjustment mechanism of an example adaptive quantization.

FIG. 6B shows example comparisons between a chroma quantization parameter (QP) adjustment mechanism of an example adaptive quantization.

FIG. 7A shows example QP arrangements for the ERP by applying the input QP to the blocks with the lowest spherical sampling density.

FIG. 7B shows example QP arrangements for the ERP by applying the input QP to the blocks with the highest spherical sampling density.

FIG. 7C shows example QP arrangements for the ERP by applying the input QP to the blocks with the intermediate spherical sampling density.

FIG. 8A shows an example comparison of the rate-distortion (R-D) costs of coding the current block as a coding block.

FIG. 8B shows an example comparison of the rate-distortion (R-D) costs of splitting the current block into four coding sub-blocks.

FIG. 9A is a system diagram illustrating an example communications system in which one or more disclosed embodiments may be implemented.

FIG. 9B is a system diagram illustrating an example wireless transmit/receive unit (WTRU) that may be used within the communications system illustrated in FIG. 9A.

FIG. 9C is a system diagram illustrating an example radio access network (RAN) and an example core network (CN) that may be used within the communications system illustrated in FIG. 9A.

FIG. 9D is a system diagram illustrating a further example RAN and a further example CN that may be used within the communications system illustrated in FIG. 9A.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Virtual reality (VR) systems may use 360-degree video to provide the users the capability to view a scene from 360-degree angles in the horizontal direction and 180-degree angles in the vertical direction. VR and 360-degree video may be the direction for media consumption beyond Ultra High Definition (UHD) service. 360-degree video may include or may be a spherical video content, an omnidirectional video content, a virtual reality (VR) video content, a panorama video content, an immersive video content (e.g., a light field video content that includes 6 degree of freedom), a point cloud video content, and/or the like. Work on the requirements and potential technologies for omnidirectional media application format may be performed to improve the quality of 360-degree video in VR and/or to standardize the processing chain for client's interoperability. Free view TV (FTV) may test the performance of one or more of the following: (1) 360-degree video (omnidirectional video) based system; (2) multi-view based system.

The quality and/or experience of one or more aspects in the VR processing chain may be improved. For example, the quality and/or experience of one or more aspects in capturing, processing, display, etc., VR processing may be improved. On the capturing side, VR may use one or more cameras to capture a scene from one or more (e.g., different) divergent views (e.g., 6-12 views). The views may be stitched together to form a 360-degree video in high resolution (e.g. 4K or 8K). On the client side and/or the user side, the virtual reality system may include a computation platform, head mounted display (HMD), and/or head tracking sensors. The computation platform may receive and/or decode 360-degree video, and/or may generate the viewport for display. Two pictures (e.g., one for each eye) may be rendered for the viewport. The two pictures may be displayed in HMD (e.g., for stereo viewing). The lens may be used to magnify the image displayed in HMD for better viewing. The head tracking sensor may keep (e.g., constantly keep) track of the viewer's head orientation, and/or may feed the orientation information to the system to display the viewport picture for that orientation.

VR systems may provide a touch device for a viewer to interact with objects in the virtual world. VR systems may be driven by a powerful workstation with graphics processing unit (GPU) support. A light VR system (e.g., Gear VR) may use a smartphone as computation platform, HMD display, and/or head tracking sensor. The spatial HMD resolution may be 2160×1200, refresh rate may be 90 Hz, and/or the field of view (FOV) may be 110 degrees. The sampling density for head tracking sensor may be 1000 Hz, which may capture fast movement. A VR system may include a lens and/or cardboard, and/or may be driven by a smartphone.

Projective representation of 360-degree video may be performed. 360-degree video compression and delivery may be performed. 360-degree video delivery may represent 360-degree information using a sphere geometry structure. For example, synchronized views (e.g., captured by the multiple cameras) may be stitched on a sphere as an integral structure. The sphere information may be projected to 2D planar surface, for example, via a predefined geometry conversion. Projection formats (e.g., equirectangular projection and/or cubemap projection) may be used.

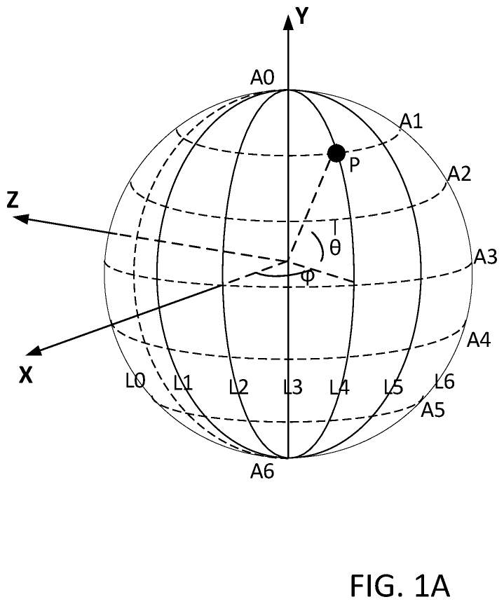

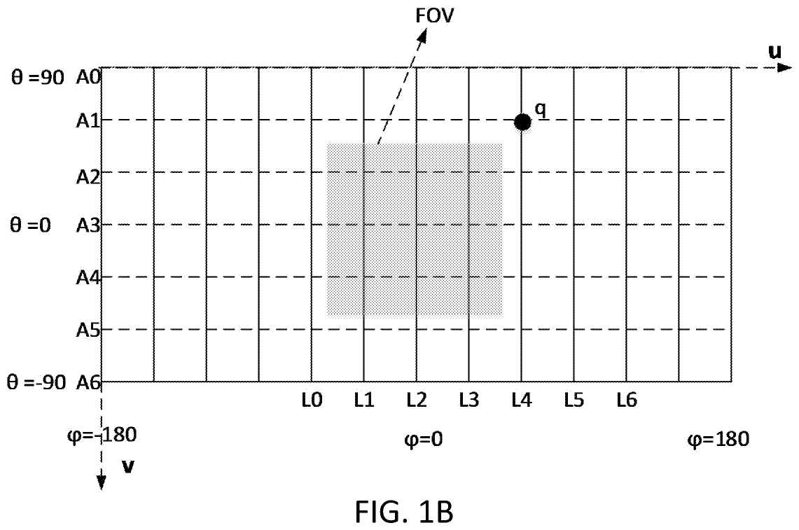

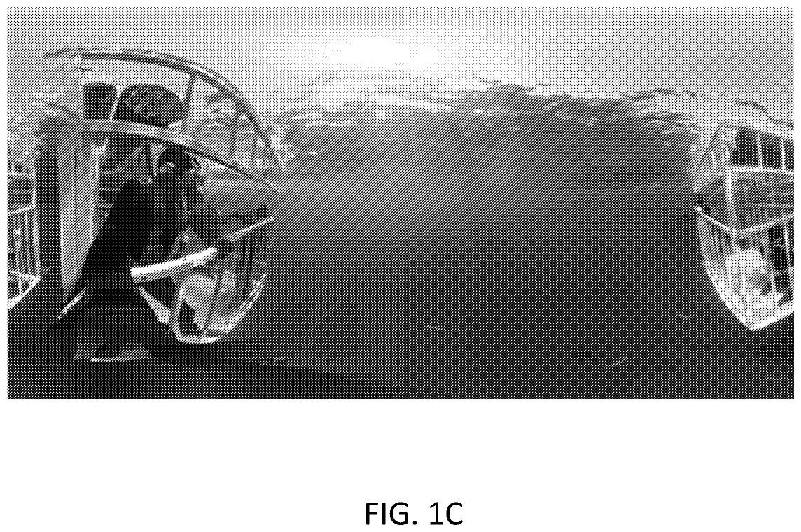

Equirectangular projection (ERP) may be performed. ERP may map latitude and/or longitude coordinates of a spherical globe. For example, ERP may map latitude and/or longitude coordinates of a spherical globe onto (e.g., directly onto) horizontal and/or vertical coordinates of a grid. FIG. 1A shows an example sphere sampling in longitude (φ) and latitude (θ). FIG. 1B shows an example sphere projected to a 2D plane using ERP. FIG. 1C shows an example ERP picture. The longitude φ in the range [−π, π] may be known as yaw. Latitude θ in the range [−π/2, π/2] may be known as pitch in aviation, where π may be the ratio of a circle's circumference to the circle's diameter. In FIG. 1A, (x, y, z) may represent a point's coordinates in 3D space. (ue, ve) may represent the coordinate of a point in 2D plane as shown in FIG. 1B. ERP may be represented mathematically in ((1) and (2)):

ue=(φ/(2*π)+0.5)*W (1)

ve=(0.5−θ/π)*H (2)

where W and H may be the width and height of the 2D planar picture. As shown in FIG. 1A, the point P, the cross point between longitude L4 and latitude A1 on the sphere, may be mapped to a unique point q in the 2D plane, as shown in FIG. 1B, using (1) and (2). The point q in 2D plane may be projected back to the point P on the sphere, for example, via inverse projection. The field of view (FOV) in FIG. 1B shows an example of the FOV in a sphere being mapped to a 2D plane, for example, with the view angle along X axis being about 110 degrees.

Cubemap projection (CMP) may be performed. As shown in FIG. 1C, the top and bottom portions of the ERP picture (e.g., which may correspond to the North Pole and the South Pole, respectively) may be stretched, for example, compared to the middle portion of the picture. Stretching the top and bottom portions of the ERP picture (e.g., compared to the middle portion of the middle portion of the picture) may indicate that the spherical sampling density is uneven for ERP format. Video codecs (e.g., MPEG-2, H.264, or HEVC) may use a translational model to describe motion field. Shape varying movement may be represented in planar ERP pictures. Geometric projection formats may map 360-degree video onto one or more faces. The CMP may be a compression friendly format.

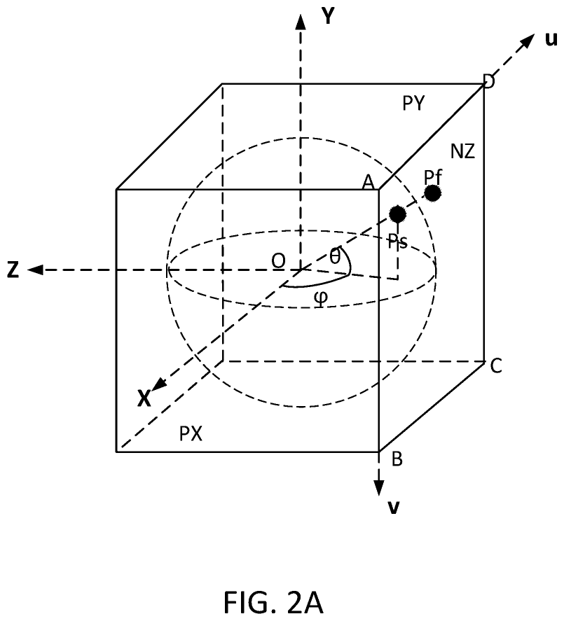

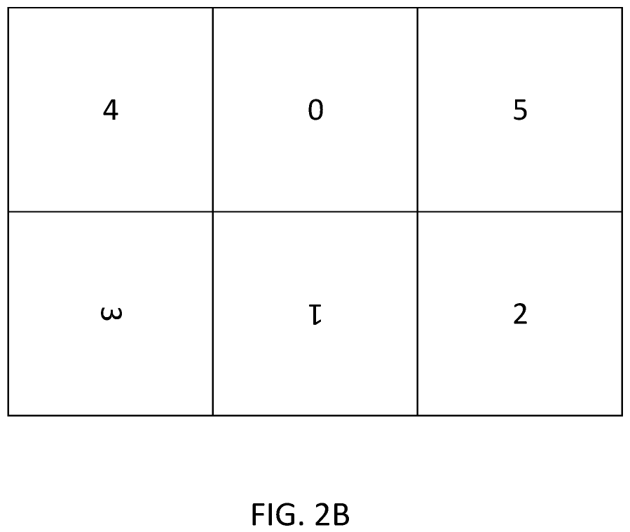

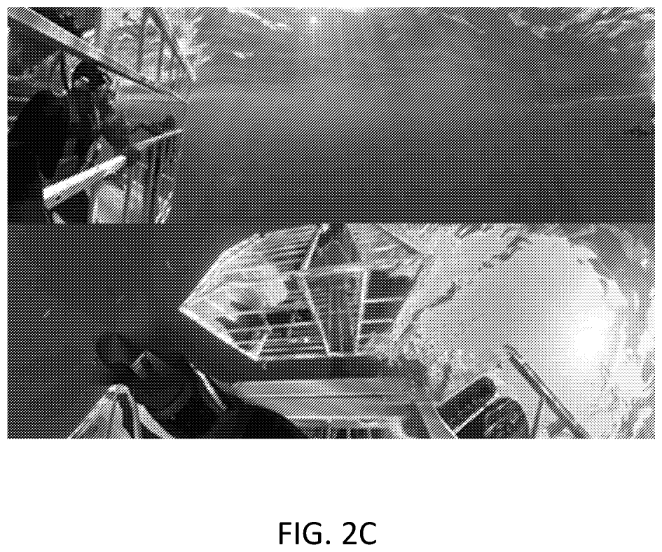

FIG. 2A shows an example 3D geometry structure, for example, an example CMP geometry. The CMP may consist of one or more (e.g., 6) square faces, for example, the faces may be labeled as PX, PY, PZ, NX, NY, NZ. P may stand for positive, N may stand for negative, and/or X, Y, Z may refer to the axes. These faces may be labeled using numbers 0-5 according to PX (0), NX (1), PY (2), NY (3), PZ (4), NZ (5). The radius of the tangent sphere may be 1. If the radius of the tangent sphere is 1, the lateral length of a (e.g., each) face may be 2. The 6 faces of CMP format may be packed together into a single picture. Faces may be rotated by a predefined degree. For example, faces may be rotated by a predefined degree to maximize the continuity between neighboring faces. FIG. 2B shows an example 2D planar for six faces, for example, an example packing to place 6 faces into a rectangular picture. A (e.g., each) face index may be put in the direction that is aligned with the corresponding rotation of the face. For example, face #3 and face #1 are rotated counter-clockwise by 270 and 180 degrees, respectively. The other faces may or may not be rotated. An example picture (e.g., projective picture) with CMP is shown on FIG. 2C.

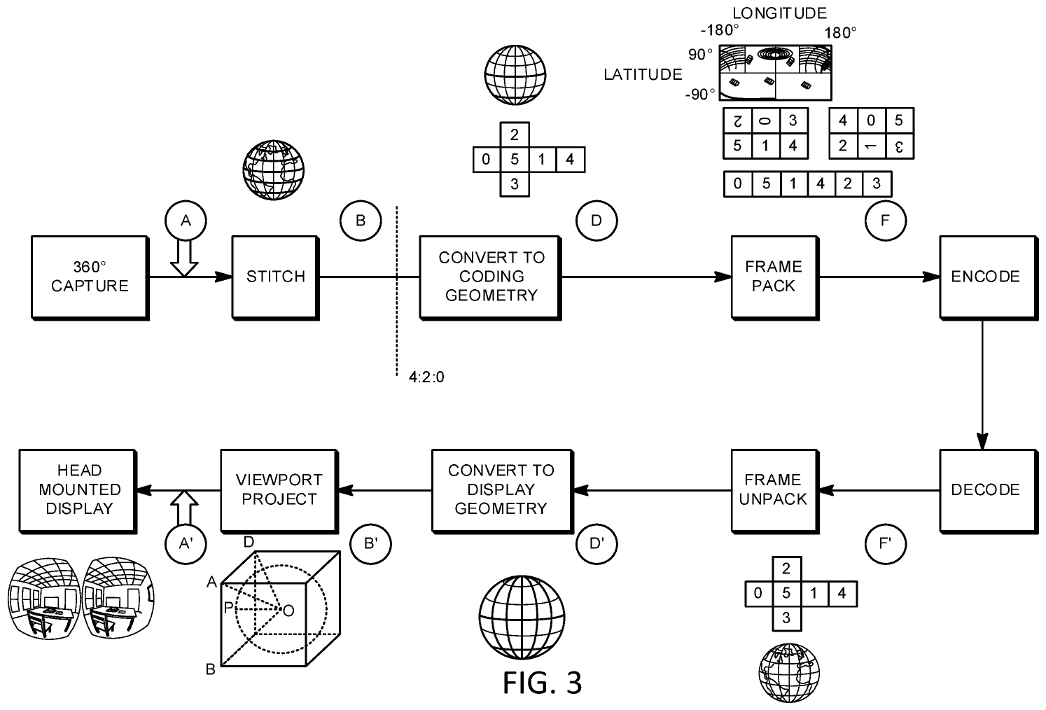

A workflow of a 360-degree video system may be provided. An example workflow for 360-degree video system is illustrated in FIG. 3. The example workflow for 360-degree video system may include a 360-degree video capturing implementation, which may use one or more cameras to capture videos covering the sphere (e.g., the entire sphere). The videos may be stitched together (e.g., stitched together in a native geometry structure). For example, the videos may be stitched together in the ERP format. The native geometry structure may be converted to another projection format (e.g., CMP) for coding, based on video codecs. At the receiver, the video may be decoded. The decompressed video may be converted to the geometry for display. The video (e.g., the decompressed video) may be used for rendering via viewport projection, for example, according to a user's viewing angle.

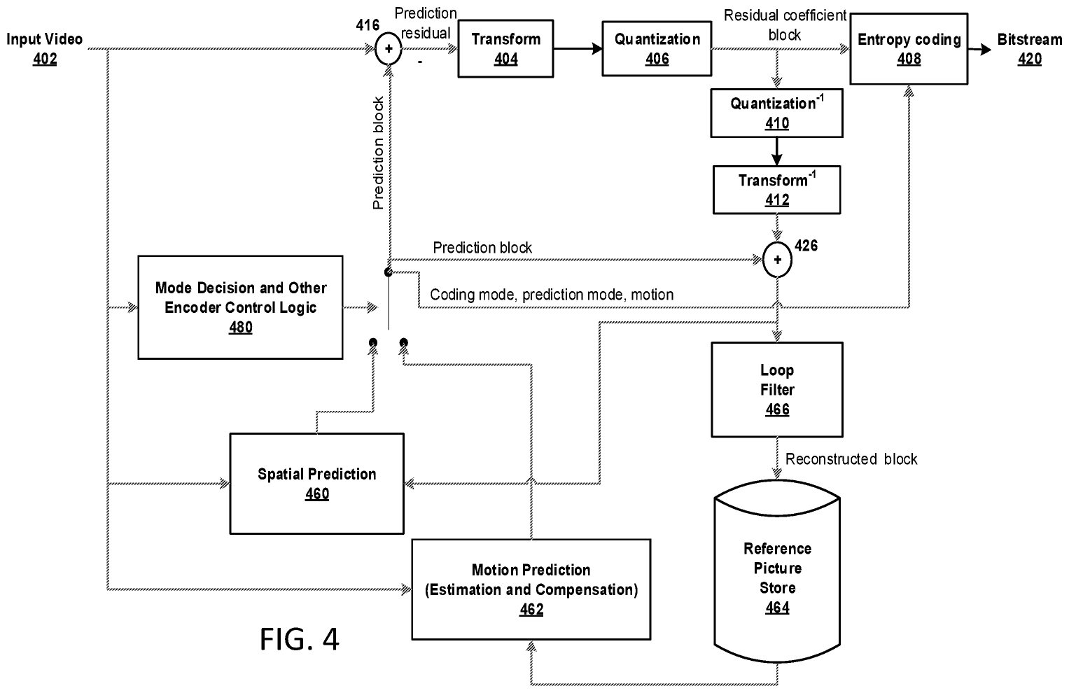

FIG. 4 shows an example block diagram of a block-based hybrid video encoding system. The input video signal 402 may be processed block by block. Extended block sizes (e.g., a coding unit (CU)) may be used to compress (e.g., efficiently compress) high resolution (1080p and beyond) video signals. A CU may be 64×64 pixels. A CU may be partitioned into prediction units (PUs), for which separate predictions may be applied. For an (e.g., each) input video block (e.g., an MB and/or CU), spatial prediction (460) and/or temporal prediction (462) may be performed.

Spatial prediction (e.g., intra prediction) may use pixels from coded neighboring blocks in the same video picture/slice, for example, to predict the current video block. Spatial prediction may reduce spatial redundancy (e.g., spatial redundancy inherent in the video signal). Temporal prediction (inter prediction, or motion compensated prediction) may use pixels from coded video pictures, for example, to predict the current video block. Temporal prediction may reduce temporal redundancy that may be inherent in the video signal. Temporal prediction signal for a given video block may be signaled by one or more motion vectors, for example, which may indicate the amount and/or the direction of motion between the current block and the current block's reference block. If multiple reference pictures are supported (e.g., for a (e.g., each) video block), the reference picture index may be sent and/or the reference index may be used to identify from which reference picture in the reference picture store (464) the temporal prediction signal may be derived.

After spatial and/or temporal prediction, the mode decision block (480) in the encoder may choose a prediction mode (e.g., the best prediction mode), for example, based on a rate-distortion optimization. The prediction block may be subtracted from the current video block (416) and/or the prediction residual may be de-correlated (e.g., using transform (404)) and/or quantized (406) to achieve the target bit-rate. The quantized residual coefficients may be inverse quantized (410) and/or inverse transformed (412) to form the reconstructed residual, which may be added back to the prediction block (426) to form the reconstructed video block. In-loop filtering, such as de-blocking filter and Adaptive Loop Filters, may be applied (466) on the reconstructed video block before the reconstructed video block is put in the reference picture store (464) and/or used to code future video blocks. A coding mode (e.g., inter or intra), prediction mode information, motion information, and/or quantized residual coefficients may be sent to the entropy coding unit. For example, to form the output video bit-stream 420, coding mode (inter or intra), prediction mode information, motion information, and/or quantized residual coefficients may be sent (e.g., all sent) to the entropy coding unit (408) to be further compressed and/or packed to form the bit-stream.

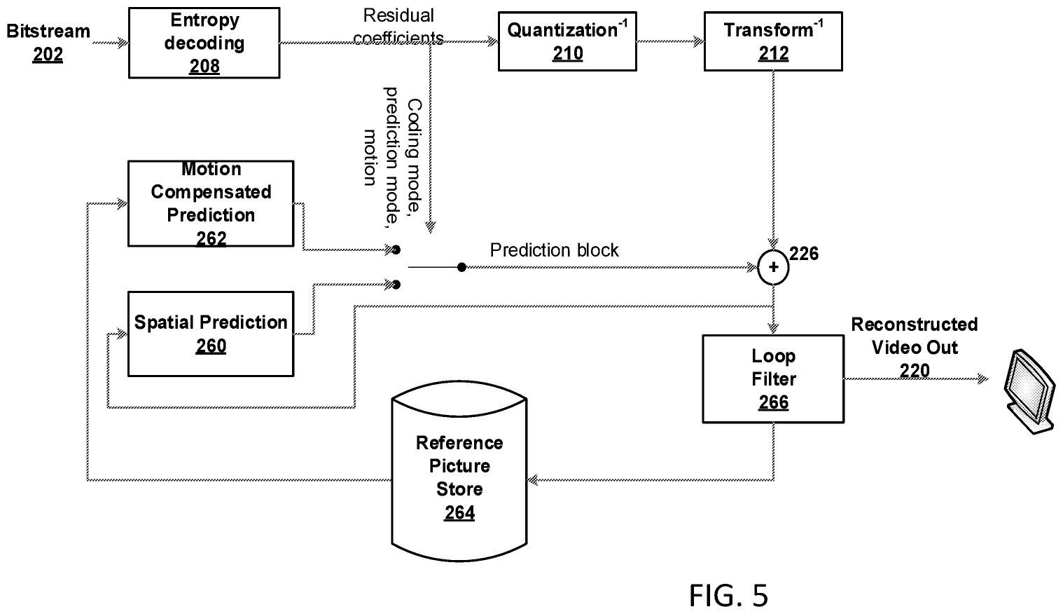

FIG. 5 shows an example block diagram of a block-based video decoder. The video bit-stream 202 may be unpacked and/or entropy decoded (e.g., first unpacked and entropy decoded) at entropy decoding unit 208. The coding mode and/or prediction information may be sent to the spatial prediction unit 260 (e.g., if intra coded) and/or the temporal prediction unit 262 (e.g., if inter coded) to form the prediction block. Parameters (e.g., coefficients) may be sent to inverse quantization unit 210 and/or inverse transform unit 212, for example, to reconstruct a block. For example, residual transform coefficients may be sent to inverse quantization unit 210 and/or inverse transform unit 212, for example, to reconstruct the residual block. The prediction block and/or the residual block may be added together at 226. The reconstructed block may go through in-loop filtering. For example, the reconstructed block may go through in-loop filtering before the reconstructed block is stored in reference picture store 264. The reconstructed video in reference picture store may be sent out to drive a display device and/or may be used to predict future video blocks.

A quantization/inverse quantization may be performed. As shown in FIG. 4 and FIG. 5, prediction residuals may be transmitted from encoder to decoder. The residual values may be quantized. For example, to reduce the signaling overhead of residual signaling (e.g., when lossy coding is applied), the residual values may be quantized (e.g., may be divided by a quantization) before being signaled into a bit-stream. A scalar quantization scheme may be utilized, which may be controlled by a quantization parameter (QP) that may range from 0 to 51. The relationship between QP and the corresponding quantization step size (e.g., Qₛₜₑₚ) may be described as:

$${Q}_{step} ( Q P ) = {2}^{\frac{QP - 4}{6}} \qquad ( 3 )$$

Given the value of a residual sample Pᵣₑₛᵢ, the quantized value of the residual sample Pᵣₑₛᵢ may be derived at the encoder (as shown in FIG. 4) as:

$$\begin{matrix}{P}_{level} = sign ( {P}_{resi} ) \cdot floor ( \frac{abs ( {P}_{resi} )}{{Q}_{step}} + dead\_zone \_offset ) \\ = sign ( {P}_{resi} ) \cdot floor ( \frac{abs ( {P}_{resi} )}{{2}^{\frac{QP - 4}{6}}} + dead\_zone \_offset )\end{matrix} \qquad ( 4 )$$

where the dead_zone_offset may be a non-zero offset that may be set to ⅓ for intra blocks and ⅙ for inter blocks; sign(·) and abs(·) may be implementations that may return the sign and the absolute value of the input signal; floor(·) may be an implementation which may round the input to the integer that is not larger than the input value. At the decoder (e.g., as shown in FIG. 5), the reconstructed value Pᵣₑₛᵢ^{r} of the residual sample may be derived, for example, by multiplying the quantization step size, as shown as:

$${P}_{r e s i}^{ r} = round ( {P}_{level} \cdot {Q}_{step} ) = round ( {P}_{level} \cdot {2}^{\frac{Q P - 4}{6}} ) \qquad ( 5 )$$

where round (·) may be an implementation which rounds the input floating value to its nearest integer. In Equations (4) and (5), Qₛₜₑₚ may be a floating number. Divisions and multiplications by floating-point numbers may be approximated, for example, by multiplying a scaling factor followed by a right shift of appropriate bits. For example, the values of 52 quantization step sizes, which may correspond to QP=0, 1, 2, . . . , 51, are in the range from 0.63 (QP=0) to 228 (QP=51). QP=4 may correspond to Qₛₜₑₚ=1. The quantization step size may increase. For example, the quantization step size may double (e.g., exactly double) for every 6 increments of QP. The quantization implementation for QP+6 k may share a scaling factor as that for QP. The quantization implementation for QP+6 k may share the scaling factor as that for QP and/or may use k more right shifts, for example, because the quantization step size associated with QP+6 k may be 2^{k} times of that of the quantization step associated with QP. With this cyclic property, 6 pairs of scaling parameters (e.g., encScale[i] and decScale[i], i=0, 1, . . . , 5), may be stored for the quantization and inverse quantization at the encoder and the decoder, respectively. Table 1 specifies the values of encScale[i] and decScale[i], where QP % 6 may represent the QP modulo 6 operation.

TABLE 1
Scaling parameters used for quantization and inverse quantization

| QP %6 | 0 | 1 | 2 | 3 | 4 | 5 |
|---|---|---|---|---|---|---|
| encScale[QP %6] | 26214 | 23302 | 20560 | 18396 | 16384 | 14564 |
| decScale[QP %6] | 40 | 45 | 51 | 57 | 64 | 72 |

The coding error (e.g., average coding error) may be calculated (e.g., if the distribution of the input video is uniform) based on the value of Qₛₜₑₚ. For example, given the quantization step size Qₛₜₑₚ, as derived in (4), the coding error (e.g., average coding error) may be calculated (e.g., if the distribution of the input video is uniform) based on the value of Qₛₜₑₚ as:

$$D = \frac{{{Q}_{step}}^{2}}{12} = \frac{1}{12} \cdot {2}^{\frac{Q P - 4}{3}} \qquad ( 6 )$$

Human vision systems may be more sensitive to variations in brightness than color. A video coding system may devote more bandwidth to luma components than to chroma components. Chroma components may be sub-sampled (e.g., 4:2:0 and 4:2:2 chroma formats) to reduce the chroma components' spatial resolution, for example, to reduce signaling overhead (e.g., without introducing significant degradation of the reconstructed quality of the chroma components). There may be less high frequency information in the chroma components than in the luma component (e.g., chroma planes may be more smooth than the luma plane), for example, due to sub-sampling. Chroma components may be quantized using a smaller quantization step size (e.g., smaller QP) than a luma component, for example, to achieve a tradeoff (e.g., a better tradeoff) in terms of the bitrate and/or the quality. Avoiding quantization (e.g., severe quantization) on the chroma components at QP values (e.g., high QP values) may reduce color bleeding, for example, at low bit rates, which may be visually objectionable. The derivation of the chroma QP may be dependent on the luma QP via a look-up table (LUT). For example, the LUT as specified in Table 2 may be used to map the QP value of luma component (e.g., QP_{L}) into the corresponding QP value that may be applied to chroma components (e.g., QP_{C}).

TABLE 2
Look-up table for mapping luma QP to chroma QP

| QP_{L} | <30 | 30 | 31 | 32 | 33 | 34 | 35 | 36 | 37 | 38 | 39 | 40 | 41 | 42 | 43 | >43 |
|---|---|---|---|---|---|---|---|---|---|---|---|---|---|---|---|---|
| QP_{C} | =QP_{L} | 29 | 30 | 31 | 32 | 33 | 33 | 34 | 34 | 35 | 35 | 36 | 36 | 37 | 37 | =QP_{L} − 6 |

Rate-distortion optimization may be performed. In video encoders, Lagrangian based rate-distortion optimization (RDO) may enhance coding efficiency and/or may determine the coding parameters (e.g., coding mode, intra prediction direction, motion vectors (MVs), etc.) based on the following Lagrangian rate-distortion (R-D) cost implementation:

J=D+λ·R (7)

where D and R may represent distortion and bitrate, and λ may be the Lagrangian multiplier. Values (e.g., different values) of λ may be used for luma and chroma components, respectively. Different values of λ may be used for luma and chroma components, for example, given that different QP values may be applied for luma and chroma components. The lambda value used for luma component (e.g., λ_{L}), may be derived as:

$${λ}_{L} = α \cdot {ɛ}_{k} \cdot {2}^{\frac{Q {P}_{L} - 12}{3}} \qquad ( 8 )$$

where α may be a factor which may be determined (e.g., determined according to whether the current picture is used as a reference picture for coding future pictures); εₖ may be a factor that may be dependent on the coding configuration (e.g., all intra, random access, low delay) and/or the hierarchical level of the current picture within a group of pictures (GOP). The lambda value used for chroma components (e.g., λ_{c}) may be derived by multiplying λ_{L} with a scaling factor that may be dependent on the QP difference between luma and chroma components, as described as:

$${λ}_{c} = \frac{1}{{w}_{c}} {λ}_{L} , {w}_{c} = {2}^{\frac{Q {P}_{L} - Q {P}_{C}}{3}} \qquad ( 9 )$$

λ_{c} may be used for chroma-specific RDO implementations, for example, rate-distortion optimized quantization (RDOQ), sample adaptive offset (SAO), and/or adaptive loop filtering (ALF) implementations.

In (7), metrics (e.g., different metrics) may be applied to calculate the distortion D, for example, sum of square error (SSE), sum of absolute difference (SAD), and/or sum of absolute transformed difference (SATD). One or more (e.g., various) Lagrangian R-D cost implementations may be applied at one or more (e.g., different) stages of the RDO implementation, for example, depending on the distortion metric that is applied, as provided herein.

A SAD based Lagrangian R-D cost implementation may be performed. For example, at the motion estimation (ME) at the encoder (e.g., as shown in FIG. 4), a Lagrangian R-D cost implementation based on SAD may be used to search the optimal integer MV for a (e.g., each) block that may be predicted from reference pictures in temporal domain. For example, the R-D cost J_{SAD} may be defined by the following formula:

J_{SAD}=D_{SAD}+λ_{pred}·R_{pred} (10)

where R_{pred} may be the number of bits that may be acquired during the ME stage (e.g., including the bits to code prediction direction, reference picture indices, and/or MVs); D_{SAD} may be the SAD distortion; λ_{pred} may be the Lagrangian multiplier that may be used at the ME stage, which may be calculated as:

λ_{pred}=\sqrt{λ_{L}} (11)

A SATD based Lagrangian R-D cost may be calculated. A SAD based R-D cost implementation in (10) may be used to determine the MV at integer sample precision at the motion compensation stage. For example, to determine the MV at fractional sample precision, a SATD based Lagrangian cost implementation may be used, which may be specified as:

J_{SATD}=D_{SATD}+λ_{pred}·R_{pred} (12)

where D_{SATD} may be the SATD distortion.

An SSE based Lagrangian R-D cost may be calculated. Encoders may use an SSE based Lagrangian implementation to calculate the R-D costs of coding modes (e.g., all coding modes), for example, to select an optimal coding mode (e.g., intra/inter coding, transform/non-transform, etc.). The coding mode that has the minimum R-D cost may be selected, for example, as the coding mode of the current block. The bitrate and/or the distortion of the luma and/or the chroma components may be considered for the SSE based cost implementation, for example, unlike the SAD based R-D cost implementation in (10) and the SATD based R-D cost implementation in (12), which may consider the luma component. A weighted SSE may be used when calculating the chroma distortion, for example, to compensate for the quality difference between the reconstructed signals of the luma and chroma channels. A weighted SSE may be used when calculating the chroma distortion, for example, to compensate for the quality difference between the reconstructed signals of the luma and chroma channels. The weighted SSE may be used when calculating the chroma distortion, for example, because QPs (e.g., different QPs) may be used for the quantization of the luma and/or chroma components. The SSE based R-D cost J_{SSE} may be specified as:

J_{SSE}=(D_{SSE}^{L}+w_{c}·D_{SSE}^{C})+λ_{L}·R_{mode} (13)

where D_{SSE}^{L} and D_{SSE}^{C} may be the SSE distortion of the luma component and the chroma component, respectively; w_{c} may be the weight as derived according to (9); R_{mode} may be the number of bits that may be used for coding the block.

Weighted spherically uniform PSNR may be calculated. The samples on the projected 2D plane may correspond to different sampling densities on the sphere, for example, depending on the projection format used to represent 360-degree video. Sampling densities may be uniform, for example, across the 2D plane. For projected spherical videos, peak signal-to-noise ratio (PSNR) may not provide a quality measurement. For example, PSNR may weigh the distortion at a (e.g., each) sample location uniformly. Uniform weight in sphere PSNR (WS-PSNR) may measure spherical video quality (e.g., measure spherical video quality directly) in the projection domain. To measure the quality of spherical video, uniform weight in sphere PSNR (WS-PSNR) may measure spherical video quality (e.g., measure spherical video quality directly) in the projection domain, for example, by assigning weights (e.g., different weights) to the samples on the 2D projection plane. The WS-PSNR metric may evaluate samples in the 2D projection picture and/or may weigh the distortion at samples (e.g., different samples), for example, based on the areas covered on the sphere,

The WS-PSNR may be calculated as:

$$W S - P S N R = 10 log ( \frac{{MAX}_{I}^{2}}{{\sum }_{x = 0}^{W - 1} {\sum }_{y = 0}^{H - 1} {( I ( x , y ) - {I}^{′} ( x , y ) )}^{2} \cdot n ( x , y )} ) \qquad ( 14 )$$

where MAX_{I} may be the maximum sample value; W and H may be the width and height of the 2D projection picture; I(x, y) and I′(x, y) may be samples (e.g., the original and reconstructed samples), for example, located at (x, y) on the 2D plane; n(x, y) may be a weight (e.g., the normalized weight), for example, associated with the sample at (x, y), which may be computed based on w(x, y). The non-normalized weight may correspond to a respective area covered by the sample on the sphere, for example,

$$n ( x , y ) = \frac{w ( x , y )}{{\sum }_{x = 0}^{W - 1} {\sum }_{y = 0}^{H - 1} w ( x , y )} \qquad ( 15 )$$

the calculation of w(x, y) may depend on the area of a sample that may be covered on the sphere. For example, for the ERP, the weight may be given as:

$${w}_{x , y} = cos ( ( y - \frac{H}{2} + \frac{1}{2} ) \cdot \frac{π}{H} ) \qquad ( 16 )$$

For the CMP, a weight (e.g., the corresponding weight at coordinate (x, y)) may be calculated as:

$${w}_{x , y} = \frac{1}{{\{ 1 + \frac{4 \cdot [ {( x + \frac{1}{2} - \frac{{W}_{f}}{2} )}^{2} + {( y + \frac{1}{2} - \frac{{H}_{f}}{2} )}^{2} ]}{{W}_{f} \cdot {H}_{f}} \}}^{3 / 2}} \qquad ( 17 )$$

where W_{f} and H_{f} may be the width the height of a CMP face.

As described herein, due to the characteristic of a projection geometry, a projection format may present a sampling property (e.g., a distinctive sampling property), for example, for the samples at regions (e.g., different regions) within a projection picture. As shown in FIG. 1C, the top and/or bottom parts of the ERP picture may be stretched, for example, compared to the middle part of the ERP picture. Stretching the top and/or bottom parts of the ERP picture (e.g., compared to the middle part) may indicate that the spherical sampling density of the region around the north pole and/or the south pole may be higher than that of the regions around equator,

As shown in FIG. 2, the regions around a face center may be shrunk and/or the regions close to face boundaries may be enlarged, for example, in a CMP face. Shrinking the regions around the face center and/or enlarging the face boundaries may demonstrate the non-uniformity of the spherical sampling of the CMP and/or may show a dense sampling rate at face boundaries and/or a sparse sampling rate at face centers.

A projection format with non-uniform spherical sampling may be used for coding 360-degree video. When a projection format with non-uniform spherical sampling is used for coding 360-degree video, the coding overhead used (e.g., spent) on a (e.g., each) region in the projected picture may be dependent, for example, on the sampling rate of the region on the sphere. Bits may be used for one or more regions with a higher spherical sampling density. Bits (e.g., more bits) may be used for regions with a higher spherical sampling density (e.g., which may result in unevenly distributed distortion from region to region in the projected picture), for example, if a constant QP is applied. The encoder may use (e.g., spend) more coding bits for regions around face boundaries than for regions around face centers, for example, because of the spherical sampling feature of the CMP. The quality of the viewports close to the face boundaries may be higher than the quality of the viewports close to the face centers. The 360-video content that viewers may be interested in may be outside the region with a good spherical sampling density.

Adaptive QP adjustment may be performed. For example, a uniform reconstruction quality may be provided among regions (e.g., different regions) on the sphere. Providing a uniform reconstruction quality among regions may be achieved by manipulating (e.g., adaptively manipulating) the QP value of one or more regions in the ERP picture, for example, to modulate the distortion according to the spherical densities of one or more regions in the ERP picture. For example, if QP₀ is the QP value that may be used at the equator of the ERP picture, the QP value for a video block at location (i, j) may be calculated based on the following formula:

QP_{i, j}=QP₀−QP_{offset}=QP₀−3×log₂(w_{i, j}) (18)

where w_{i, j} may be the weight at location (i, j), for example, that may be derived according to the weight calculation of the WS-PSNR as in (16). The weight w_{i, j} may be an implementation of the vertical coordinate j (e.g., latitude) and/or may not depend on the horizontal coordinate i (e.g., longitude), for example, due to the characteristic of the ERP format. Following equation (18), the QP at the poles may be larger than QP₀ (e.g., the QP value at the equator). The calculated QP value may be clipped to an integer and/or may be limited to the range [0, 51]. The calculated QP value may be clipped to an integer and/or may be limited to the range [0, 51] to prevent overflowing, for example,

QP_{i, j}=min(51, floor(QP₀−3×log₂(w_{i, j}))) (19)

Weight normalization may be used in (18) and (19). When determining the weight value for a block, the average of the weight values for the samples in the block may be used for calculating the QP value of the block, for example, according to (19).

As described herein, the derivation of the chroma QP of a block may be dependent on the value of the block's luma QP. For example, the derivation of the chroma QP of a block may be dependent on the value of the block's luma QP based on a LUT (e.g., as shown in Table 2). The chroma QP of a video block may be calculated (e.g., when the QP adjustment is applied) by one or more of the following: calculating the modified QP value that may be applied to the luma component of the block, for example, based on the block's coordinate according to (18) to (19); and/or mapping the modified QP value of the luma component to the corresponding QP value that may be applied to chroma components (e.g., as specified in Table 2). The mapping relationship between the luma QP and the chroma QP may not have one-to-one mapping, for example, as shown in Table 2. For example, when the luma QP is larger or equal to 30, two different luma QPs may be mapped to the same chroma QP. Different values of QP adjustment (e.g., QP_{offset} in (18)) may be applied to the luma and/or chroma components for a block.

As described herein, one or more (e.g., different) Lagrangian R-D cost implementations may be applied at different encoding stages. When the QP adjustment is applied, the same lambda value (e.g., which may be determined based on (8) according to the QP value that may be used for the picture/slice (e.g., the entire picture/slice)) may be used for the RDO implementation for the coding blocks inside the projection picture. The same lambda value may be used for the RDO implementation for the coding blocks. The difference of the QP values that may be used for coding different regions inside the projection picture may be considered. For example, as shown in FIG. 1C, larger QPs may be used for ERP regions which may present higher spherical sampling density (e.g., smaller weight), such as regions closer to the poles. The lambda value for coding blocks may be increased in the regions (e.g., regions closer to the poles). By increasing the lambda value for coding blocks in the regions, some bitrates may be shifted (e.g., shifted from the coding of regions with a higher spherical sampling density to the coding of regions with a lower spherical sampling density). Shifting bitrates from the coding of regions with a higher spherical sampling density to the coding of regions with a lower spherical sampling density may achieve a more uniform reconstruction quality across regions on the sphere.

An adaptive quantization may be performed. An adaptive quantization may enhance the performance of 360-degree video coding. Enhancements of the adaptive quantization may include one or more of the following.

When applying adaptive QPs, the adjustment of the chroma QP may be dependent on that of the luma QP. When applying adaptive quantization, the luma QP and/or the chroma QP may be manipulated (e.g., independently manipulated) for a (e.g., each) coding block. For example, the luma QP and/or the chroma QP may be manipulated (e.g., independently manipulated) for a (e.g., each) coding block depending on the coding block's sampling density on the sphere. Based on chroma samples having a smaller dynamic range than luma samples (e.g., being smoother), unequal QP offsets may be applied for the luma and chroma components when adjusting the QP values of a coding block.

The lambda and/or weight factors for the RDO implementation at the encoder-side may be calculated, for example, when the adaptive quantization is applied. The RDO parameters (e.g., the lambdas and/or weights that may be used for ME and mode decision) may be determined (e.g., adaptively determined). For example, the RDO parameters (e.g., the lambdas and weights that are used for ME and mode decision) may be determined (e.g., adaptively determined) according to the QP values that may be applied to the luma and/or chroma components of the block.

QP adjustment for a luma component may be performed. The luma QP values may be modified (e.g., adaptively modified) to modulate the distortion of the luma samples in one or more regions of a projection picture, for example, according to the spherical sampling densities of one or more regions. For example, the luma QP values may be modified in one or more regions of a projection picture (e.g., according to their spherical sampling density) because the QP offset may be identified (e.g., calculated, received, etc.) based on the spherical sampling density of the one or more regions. QP adjustment may (e.g., may only) be applicable to the ERP and/or a QP adjustment may be applicable in a more general manner. The luma QP of a coding block may be calculated when an adaptive quantization is applied, for example, for coding 360-degree video.

The WS-PSNR may indicate spherical video quality. If the WS-PSNR is used to measure spherical video quality, the average quantization error (as show in (6)) may become:

$$D = δ \cdot \frac{{{Q}_{step}}^{2}}{12} = \frac{δ}{12} \cdot {2}^{\frac{Q P - 4}{3}} \qquad ( 20 )$$

where δ may be the weighting factor as derived by WS-PSNR. QP₀ may denote the QP value that may be used for the anchor block, for example, which may present the lowest spherical sampling density in the projection picture (e.g., the blocks at the equator of ERP pictures and the blocks at the face centers of CMP pictures). The spherical distortion of the anchor block may be calculated as:

$${D}_{0} = \frac{{δ}_{0}}{12} \cdot {2}^{\frac{Q {P}_{0} - 4}{3}} \qquad ( 21 )$$

where δ₀ may be the weight that is applied to the anchor block. Given another sample at coordinate (x, y) in the projection picture, to achieve the uniform spherical distortion, the corresponding QP (e.g., QP_{(x, y)}), may satisfy the following condition:

$${D}_{( x , y )} = \frac{{δ}_{( x , y )}}{12} \cdot {2}^{\frac{Q {P}_{( x , y )} - 4}{3}} = \frac{{δ}_{0}}{12} \cdot {2}^{\frac{Q {P}_{0} - 4}{3}} \qquad ( 22 )$$

where δ_{(x, y)} may be the weight associated with the sample at coordinate (x, y). The QP_{(x, y)} may be calculated as:

$$Q {P}_{( x , y )} = Q {P}_{0} - Q {P}_{offset} = {QP}_{0} - {log}_{2} ( \frac{{δ}_{( x , y )}}{{δ}_{0}} ) \qquad ( 23 )$$

Considering the QP value is an integer, (23) may be modified as:

$$Q {P}_{( x , y )} = round ( {QP}_{0} - {log}_{2} ( \frac{{δ}_{( x , y )}}{{δ}_{0}} ) ) \qquad ( 24 )$$

A rounding implementation may be used and a clipping (e.g., an unnecessary clipping) may be removed.

As shown in (24), the calculation of the adjusted QP value may be based on the coordinate of a sample. To determine the QP value that may be used for a block, one or more implementations may be applied. For example, the coordinate of a predetermined sample (e.g., top-left, center, bottom-left, etc.) in the current block may be selected to determine the QP value that may be used for the block (e.g., the entire block) according to (24). The weight values for samples (e.g., all samples) in the current block may be determined and/or the average of the weight values may be used for deriving the adjusted QP value of the block, as shown in (24). The sample-based QP values may be calculated based on a predetermined weight of a sample in the current block, according to (24). The average of the sample-based QPs may be used as the QP value (e.g., the final QP value), for example, that may be applied to a block (e.g., the current block).

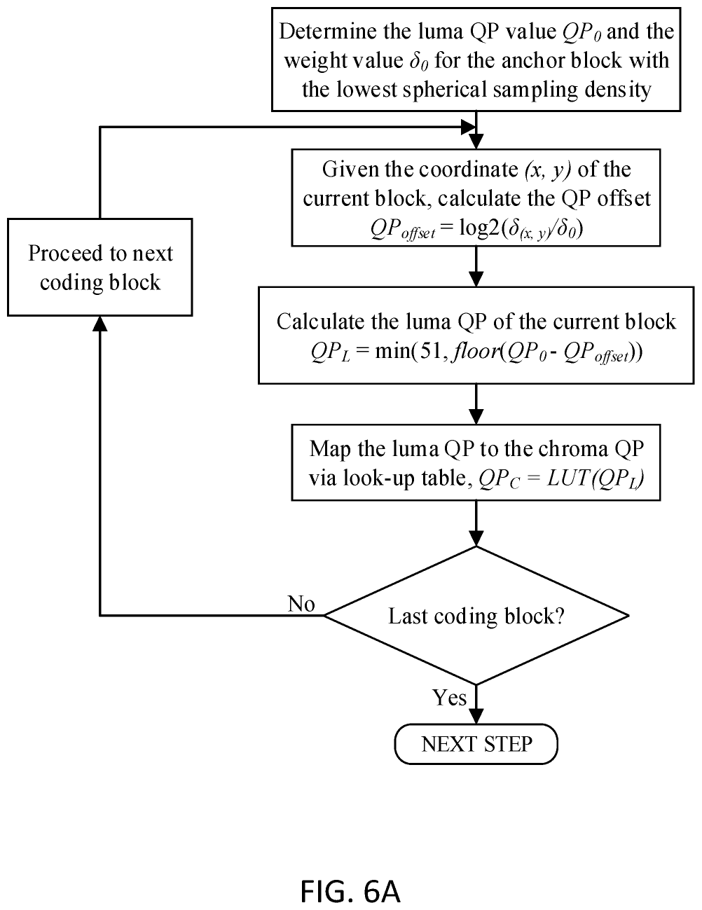

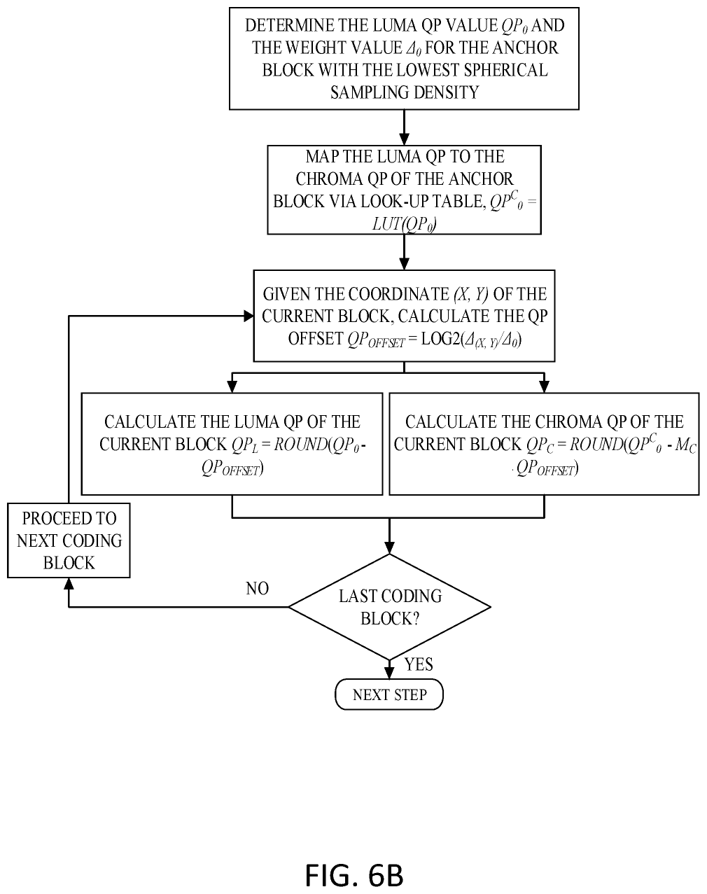

A QP adjustment for a chroma component may be performed. The chroma QP for a coding block may be determined, for example, when adaptive quantization is applied for coding 360-degree video. FIG. 6A illustrates an example calculation of the chroma QP for a coding block used by a QP adjustment. As shown in FIG. 6A, the adjusted value of chroma QP of a block may be dependent on the adjusted value of luma QP. For example, the chroma QP may be derived by computing the modified value of the luma QP (e.g., QP_{L}) of the block according to (19). The value of QP_{L} may be mapped to the corresponding chroma QP (e.g., QP_{C}) applied to the block.

A QP value (e.g., a chroma QP value and/or a luma QP value) may be determined for one or more coding blocks. For example, a chroma QP value may be independently determined for one or more coding blocks. Adaptive quantization may be performed for the chroma block components. Independent QP adjustments may be performed on the luma component and the chroma components of a (e.g., each) coding block. For example, independent QP adjustments may apply to the luma component and the chroma components of a (e.g., each) coding block based on the sampling density of the block on the sphere.

FIG. 6B shows an example flowchart of a QP adaptation. For example, an anchor block may be a block to which a picture and/or slice level QP (e.g., signaled QP) may be applied. QP values that may be applied to the luma component and/or the chroma components of the anchor block (e.g., QP₀ and QP^{c}₀) may be identified. The weight value that may be applied to the anchor block (e.g., δ₀) may be determined. QP values applied to the chroma components of the anchor block (e.g., QP^{c}₀) may be determined based on QP values applied to the luma components of the anchor block (e.g., QP₀). The QP offset (e.g., QP_{offset}) for the current block may be derived based on the coordinate (x, y) of the current block and/or the coordinate (x, y) of the anchor block (e.g., log₂(δ_{(x, y)}/δ₀) as shown in (23)). For example, the QP offset may be derived based on the spherical sampling density of the current block and/or the spherical sampling density of the anchor block. The luma QP of the current block may be calculated by applying the offset to QP₀ (e.g., subtracting the QP_{offset} from QP₀, adding the QP_{offset} to QP₀, and/or the like). The chroma QP of the current block may be calculated by applying the offset to QP^{c}₀ (e.g., subtracting the QP_{offset} from QP^{c}₀, adding the QP_{offset} to QP^{c}₀, and/or the like).

The anchor block may be identified. The luma QP value QP₀ and/or the corresponding weight value δ₀ of the anchor block may be determined. QP₀ may be mapped to the chroma QP value of the anchor block, e.g., QP^{c}₀=LUT(QP₀).

The weight value of the block (e.g., the anchor block) may be determined. The QP offset that may applied to the current block may be determined (e.g., calculated). For example, given the coordinate (x, y) of the current coding block, the weight value δ_{(x, y)} of the block (e.g., the current block) may be determined. The QP offset that may applied to the current block may be determined. The weight value δ(_{x, y}) and/or the weight value δ₀ may be calculated based on the block sampling density. QP_{offset} may be equal to log2(δ_{(x, y)}/δ₀).

The luma QP and the chroma QP of the current block may be calculated. For example, the luma QP and the chroma QP of the current block may be calculated by applying a QP offset (e.g., the same QP offset) to the luma and chroma components separately, e.g.,

QP_{(x, y)}=round(QP₀−QP_{offset}), QP^{c}_{(x, y)}=round(QP^{c}₀−QP_{offset}) (25)

A human vision system may be more sensitive to variations in brightness than color. A video coding system may devote more bandwidth to the luma component, for example, because a human vision system may be more sensitive to variations in brightness than color. Chroma samples may be subsampled, for example, to reduce spatial resolution (e.g., in 4:2:0 and 4:2:2 chroma formats) without degradation of the perceived quality of the reconstructed chroma samples. The chroma samples may have a small dynamic range (e.g., may be smoother). Chroma samples may contain less significant residuals than luma samples may contain. When adaptive quantization is applied to 360-degree video coding, a smaller QP offset may be applied to the chroma components than may be applied to the luma component, for example, to ensure that the chroma residual samples are not overly quantized. Unequal QP offsets may be applied to the luma and/or the chroma components, for example, when adjusting the QP values of a coding block. A weight factor may be used in (25) when calculating the value of the QP offset that may be applied to the chroma components, for example, to compensate for the difference between the dynamic ranges of the luma residual samples and the chroma residual samples. The calculation of the luma QP and/or the chroma QP of a coding block (e.g., as specified in (25)) may become:

QP_{(x, y)}=round(QP₀−QP_{offset}), QP^{c}_{(x, y)}=round(QP^{c}₀−μ_{c}·QP_{offset}) (26)

where μ_{c} may be the weight parameter (e.g., factor) that may be used to calculate the QP offset of the chroma components.

When (26) is applied, the value of p may be adapted at different levels. The value of μ_{c} (e.g., 0.9) may be fixed at a sequence-level, for example, such that a weight factor (e.g., the same weight factor) may be used for the quantization of the chroma residual samples in one or more of the pictures in a video sequence (e.g., the same video sequence). One or more (e.g., a set of) parameters (e.g., predefined weight parameters) may be signaled at a sequence level (e.g., signaled at video parameter set (VPS), sequence parameter set (SPS)). The weight parameters may be selected for a picture/slice, for example, according to the respective characteristics of the picture/slice's residual signals. Weight parameters (e.g., different weight parameters) may be applied to the Cb and/or Cr components. For example, weight parameters (e.g., different weight parameters) may be applied to the Cb and/or Cr components separately. The value of μ_{c} may be signaled in a Picture Parameter Set (PPS) and/or a slice header. For example, the value of μ_{c} may be signaled in a PPS and/or a slice header to allow a picture and/or slice level adaptation. The determination of the weight parameter may be dependent on the value of the input luma QP (e.g., QP₀ in (25) and (26)). A (e.g., one) LUT may specify the mapping between QP₀ and μ_{c}, and/or may be used by the encoder and/or decoder.

Adaptive QP adjustment may be granularized. For example, when an adaptive QP is applied to 360-degree video coding, the adaptation of the QP values may be conducted at one or more levels, such as at a coding unit (CU) level and/or a coding tree unit (CTU) level. An indication of the QP adjustment level (e.g., coding unit, coding tree unit, etc.) that may be used may be signaled. A (e.g., each) level may provide a granularity (e.g., a different granularity) of changing the QP values. For example, if the QP adjustment is carried over at a CU level, the encoder/decoder may adjust (e.g., adaptively adjust) the QP value for individual CUs. If the QP adjustment is performed at a CTU level, the encoder/decoder may adjust (e.g., may be permitted to adjust) the QP value for individual CTUs. The CUs (e.g., all the CUs) inside the CTU may use a QP value (e.g., may use the same QP value). Region-based QP adjustment may be performed. A projection picture may be divided into regions (e.g., predefined regions). QP values (e.g., different QP values) may be assigned (e.g., adaptively assigned) by an encoder/decoder to a (e.g., each) region.

Adaptive quantization may be based on arrangements (e.g., different arrangements) of QP values. As show in FIG. 6B, an example adaptive quantization may use the input QP (e.g., as signaled at slice header) for the blocks that may correspond to a spherical sampling density (e.g., the lowest spherical sampling density) in the projection picture (e.g., QP₀ in (25) and (26)). An adaptive quantization may increase (e.g., gradually increase) the QP value for certain blocks (e.g., blocks with higher spherical sampling density).

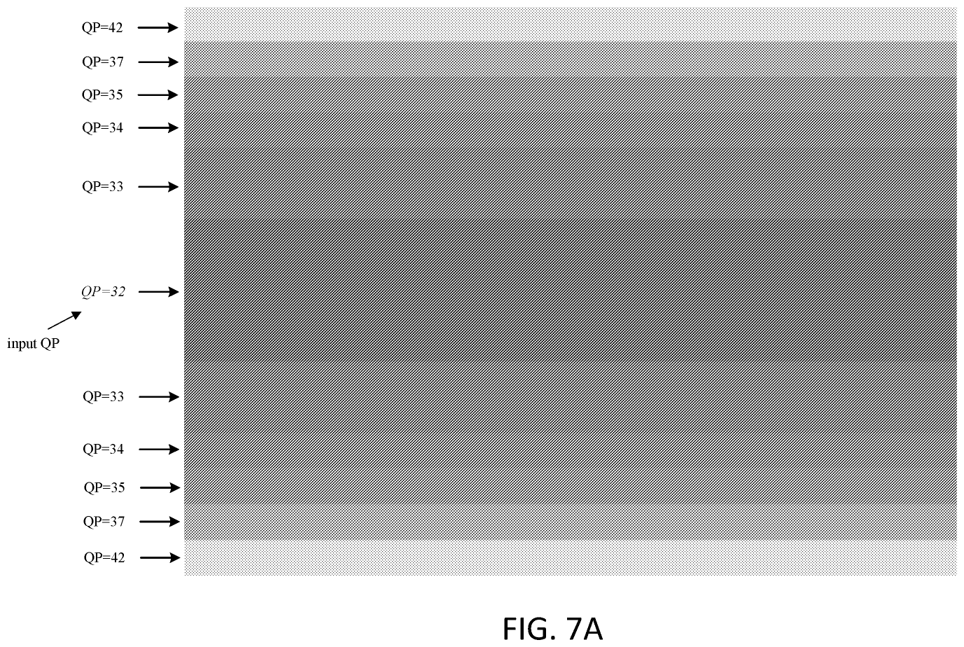

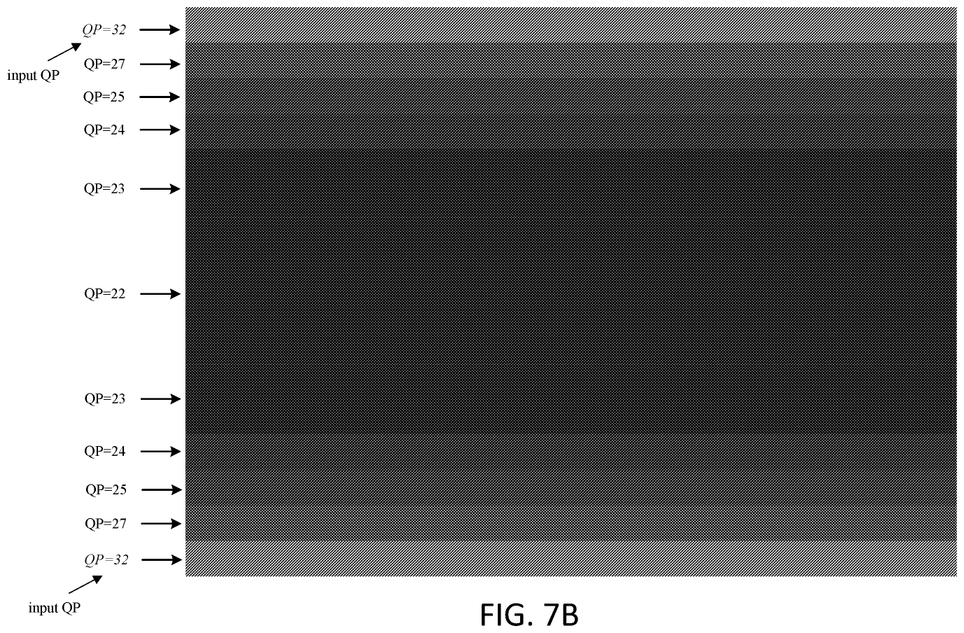

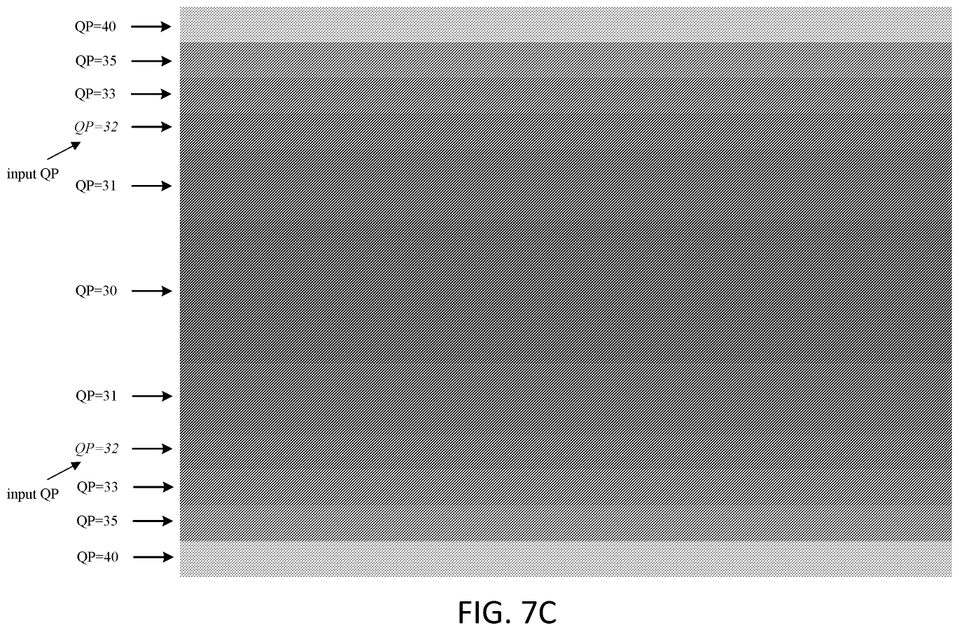

FIG. 7A illustrates an example variation of the QP values for the ERP picture based on the QP arrangement (described herein) when the input QP is 32. As can be seen in FIG. 7A, the QP value may be set equal to the input QP for the blocks around the picture center, and/or may be gradually increased when coding the blocks close to the top and/or bottom boundaries of the picture, for example. The spherical sampling density of the ERP may be lowest at the equator and highest at north and/or south poles. The input QP may be applied for coding the blocks which correspond to the highest spherical sampling density (e.g., highest spherical sampling density on the sphere), and/or may decrease (e.g., gradually decrease) the QP value for the blocks with lower sampling density (e.g., lower sampling density on the sphere). The input QP may be applied for the blocks that correspond to the intermediate spherical sampling density (e.g., the average spherical sampling density over samples (e.g., all samples) in the projection picture), and/or may increase/decrease (e.g., gradually increase/decrease) the QP value for the coding blocks whose spherical sampling may be higher/lower than the average. Based on the input QP value in FIG. 7A, FIG. 7B and FIG. 7C illustrate the corresponding variation of the QP values when the second and third QP arrangement are applied, respectively. The third QP arrangement may reduce the probability of QP clipping (e.g., because QP may be within 0 and 51, inclusive) due to adjusting by QP_offset (e.g., positive and/or negative) that may have an absolute value (e.g., a large absolute value). A syntax element adaptive_qp_arrangement_method_idc (which may be indexed by 0, 1 and 2, e.g., 2-bits) may be signaled in an SPS, a PPS, and/or slice header, for example, to indicate which QP arrangement may be applied.

An indication of adjusted QP values may be provided to a decoder. For example, based on the equations (25) and (26), as QP values (e.g., varying QP values) are applied to regions (e.g., different regions, such as different blocks) in a projection picture, the QP values may be provided (e.g., informed) by the encoder to the decoder. Syntax elements on delta QP signaling may be used to provide (e.g., signal) the adjusted QP value from the encoder to the decoder. The adjusted QP of a (e.g., each) coding block may be predicted from the QP of the coding block's neighboring block. The difference (e.g., only the difference) may be provided (e.g., signaled) in bit-stream.

A derivation may be performed. The derivation (as shown in (25) and (26)) may be used to calculate the QP value for a (e.g., each) block at the encoder and/or the decoder. As can be seen from (16), (17), and (24), the cosine, square root, and/or logarithm implementations may be used to derive the values of the weight and/or the QP offset that may be applied to the current block. The implementations are non-linear implementations and/or may be based on floating-point operations. The adjusted QP values may be synchronized at the encoder and decoder, for example, while avoiding floating-point operations when the adaptive quantization is applied for 360-degree video coding.

When the adaptive quantization is applied, a mapping g(x, y) may be used to specify the relationship between the 2D coordinate (x, y) of a predefined sample in the projection picture and/or the corresponding QP offset (e.g., QP_{offset} as calculated in (23)). The QP offset may be applied to the sample compared to the QP value of the anchor block, for example, QP_{offset}(x, y)=g(x, y). The horizontal and/or vertical mapping implementations may be uncorrelated. The mapping implementation g(x, y) may be separated into two implementations, e.g., g(x, y)=f(x)·f(y), where the mapping implementations in x- and y-directions may be identical. Different modeling may be applied, e.g., a polynomial implementation, exponential implementation, logarithm implementation, etc., may be applied. One or more (e.g., different) modeling implementations may be applied to approximate the mappings. The 1st-order polynomial model (e.g., linear model) may be used for the modeling. The QP offset that is applied to the sample at location (x, y) in the projection picture may be calculated as:

QP_{offset}(x, y)=f(x)·f(y)=(a₁x+a₀)·(a₁y+a₀) (27)

The values (e.g., only the values) that are polynomial parameters may be sent from an encoder to a decoder, for example, such that QP offsets (e.g., the same QP offsets) that may be used for coding blocks during the encoding may be duplicated at the decoder side. As shown in (27), the polynomial parameters (e.g., a₀ and a₁) may be real numbers. The polynomial parameters may be quantized, for example, before sending to the decoder. To deliver the parameters of the modeling implementation, the following syntax elements in Table 3 may be used in SPS and/or PPS (e.g., if the linear modeling is applied).

TABLE 3
Syntax elements of signaling the parameters of the
modeling implementation for calculating QP offset

Descriptor

qp_offset_modeling_parameter_set( ) {

| | |
|---|---|
| adaptive_qp_arrangement_method_idc | u(2) |
| para_scaling_factor_minus1 | ue(v) |
| para_bit_shift | ue(v) |
| for ( k = 0; k < 2; k++ ) { | |

| | |
|---|---|
| modeling_para_abs[k] | ue(v) |
| modeling_para_sign[k] | ue(v) |

}

}

Parameter adaptive_qp_arrangement_method_idc may specify which QP arrangement may be used to calculate the quantization parameter of a coding block. For example, when adaptive_qp_arrangement_method_idc is equal to 0, the quantization parameter that is indicated in the slice header may be applied to the coding block with the lowest spherical sampling density. When adaptive_qp_arrangement_method_idc is equal to 1, the quantization parameter that is indicated in the slice header may be applied to the coding block with the highest spherical sampling density. When adaptive_qp_arrangement_method_idc is equal to 2, the quantization parameter that is indicated in the slice header may be applied to the coding block with the intermediate spherical sampling density.

Parameter para_scaling_factor_minus1 plus one (e.g., para_scaling_factor_minus1+1) may specify the value of a scaling factor that may be used to calculate the parameters of the modeling implementation of quantization parameter offsets.

Parameter para_bit_shift may specify the number of right shifts used to calculate the parameters of the modeling implementation of quantization parameter offsets.

Parameter modeling_para_abs[k] may specify the absolute value of the k-th parameter of the modeling implementation of quantization parameter offsets.

Parameter modeling_para_sign[k] may specify the sign of the k-th parameter of the modeling implementation of quantization parameter offsets.

Parameter modeling_para_abs[k] and/or modeling_para_sign[k] may specify the value of the k-th parameter for the modeling implementation for calculating the quantization parameter offsets as:

QPOffsetModelingPara[k]=((1−2*modeling_para_sign[k]*modeling_para_abs[k]*(para_scaling_factor_minus1+1))>>para_bit_shift

As described herein, a linear model (e.g., the same linear model) may be used to approximate the mapping implementations in x- and y-directions, for example, to facilitate the syntax signaling. The syntax elements may be applicable to one or more (e.g., other approximations). For example, the syntax elements may be applicable to implementations that may use models (e.g., more complicated models) and/or apply different model implementations in x- and y-directions. As shown in (27), the value of the QP offset may be calculated based on x- and/or y-coordinates. The value of the QP offset may not be calculated independently from x- and/or y-coordinates. For example, as indicated by (16), the weight values used in the ERP format may be dependent (e.g., only dependent) on the vertical coordinate. The QP offset implementation may be an 1D implementation of the vertical coordinate, for example, when modeling is applied for the ERP.

The value of the QP offset that may be applied to a (e.g., each) unit block (e.g., depending on the granularity of adaptive QP adjustment as described herein) may be signaled (e.g., directly signaled) when the adaptive quantization is applied for 360-degree video coding. For example, if the QP adaptation is performed at a CTU level, the QP offset value for a CTU in a projection may be signaled in a bit-stream. The QP offsets of a face may be signaled, for example, given that the 3D projection of a 360-degree video onto multiple faces may be symmetric. For example, the QP offsets may be signaled for a subset of CTUs inside a face, which may be re-used by other CTUs within a face (e.g., the same face). The weights derived to adjust the QP values for the ERP may be vertically symmetric and/or may rely on the vertical coordinates (as shown in (16)). An indication may be provided of the QP offsets that may be applied to the CTUs (e.g., in the top half of the first CTU column). As shown in (17), the weight calculation applied for the CMP may be symmetric in horizontal and/or vertical directions. The QP offsets for the CTUs may be indicated in the first quarter of a CMP face (e.g., the top-left quarter) in a bit-stream. The syntax elements, as shown in Table 4, may transmit the QP offsets of the signaled CTUs from the encoder to the decoder.

TABLE 4
Syntax elements of signaling the QP offsets

Descriptor

adaptive_qp_offset set( ) {

| | |
|---|---|
| num_qp_offset_signaled | ue(v) |
| for ( k = 0; k < num_qp_offset; k++ ) { | |

| | |
|---|---|
| qp_offset_value[k] | se(v) |

}

}

Parameter num_qp_offset_signaled may specify the number of quantization parameter offsets that are signaled in a bit-stream.

Parameter qp_offset_value[k] may specify the value of the k-th quantization parameter offset.

The value of a QP offset may be predictively signaled. The QP offset that is used for a block may be similar to that of its spatial neighbors. For example, given the limited spherical distance between neighboring blocks (e.g., especially considering that 360-degree video may be captured in high-resolution, e.g., 8K or 4K), the QP offset that is used for a block may be similar to that of its spatial neighbors. Predictive coding may be applied to code the QP offset. For example, the QP offset of a block may be predicted from the QP offset of one or more of neighboring blocks (e.g., the left neighbor). A difference may be signaled in a bit-stream.

A LUT may be used to pre-calculate and/or store a QP offset (e.g., the corresponding QP offset) that may be applied to a unit block. The LUT may be used at the encoding and/or decoding, for example, such that a QP offset (e.g., the same QP offset) that is applied at the encoder may be reused at the decoder. The projection picture within a (e.g., each) face may be symmetric. The QP offsets (e.g., only the QP offsets) of a subset of the blocks in the face may be stored. The QP offsets may be re-used for one or more other blocks within the face (e.g., the same face). The QP offsets may not be signaled. The LUT information may be stored in memory. For example, memory size (e.g., the total memory size) used for the LUT storage may be determined by the resolution of the projection picture (face). As shown in (23) and (24), the weights that may be applied for the blocks in the projection picture may take different values, which may result in varying QP offsets being applied at one or more (e.g., different) blocks.

A LUT may be defined based on a sampling grid, for example, a sampling grid that may have a resolution that may be lower than that of the original projection picture. The coordinate of the block in the high resolution may be converted into another coordinate on the sampling grid with lower resolution, for example, when calculating the QP offset of a unit block in the projection picture. The QP offset value that is associated with the converted coordinate (e.g., the one on the lower resolution sampling grid) may be used as the QP offset of the current block. If the coordinate is not converted into an integer location on the sampling grid of the LUT, the QP offset value from the nearest neighbor may be used. Interpolations (e.g., bilinear filter, cubic filter, Gaussian filter, and so forth) may be applied, for example, to calculate the QP offset at fractional sampling locations. As shown in FIG. 7, the distribution of the QP offsets may be uneven in the ERP picture. For example, the variation of the OP values in the regions with higher spherical sampling (e.g., the regions close to the poles) may be larger than those in the regions with lower spherical sampling (e.g., the regions close to the equator). The LUT may be based on uneven sampling. For example, more sampling points may be assigned for the regions with more varying QP values. Fewer sampling points may be provided for regions with less varying QP values.

De-blocking filtering with adaptive quantization may be performed. For example, the OP value as derived in (25) and (26) may be applied to coding implementations (e.g., where the QP values may be referred). In a de-blocking implementation, the QP values of a coding block may be used for the luma and/or chroma components, for example, to determine the strength of the filter (e.g., the selection between the strong filter and the normal filter) and/or how many samples on a (e.g., each) side of a block boundary may be filtered. The adjusted QP values of a coding block may be used during the de-blocking of the block. The de-blocking may be invoked more frequently at high QP values compared to low QP values, for example, given that the de-blocking filtering decision may be dependent on a QP value. When the above is applied for 360-degree video coding, the regions with higher spherical sampling density may be associated with larger QP values, for example, compared to that of the regions with lower spherical sampling density. The strong de-blocking may be more likely to be performed in regions having a higher spherical sampling density. Strong de-blocking being performed in regions having a higher spherical sampling density may not be desirable, for example, when the regions comprise complicated texture and/or abundant directional edge information. The QP values of the blocks with lower spherical sampling density (e.g., lower QP values) may be used for the de-blocking filtering decision of the blocks (e.g., all the blocks) in the projection picture.

Modified R-D criteria may be provided. The R-D optimization may be performed when the adaptive quantization is applied for 360-degree video coding. As described herein, different coding blocks within the projection picture may apply varying QP values, for example, when an adaptive QP is applied. The values of Lagrangian multipliers (e.g., λ_{pred} in (10) and (12) and λ_{L} in (13)) and/or the value of a chroma weight parameter (e.g., w_{c} in (13)) of a block may be changed with its (e.g., the block's) adjusted QP value, for example, to achieve the optimal R-D decision. The values of λ_{pred} and λ_{L} may be increased, for example, for the projection regions with high spherical sampling density. The values of λ_{pred} and λ_{L} may be increased to save bits that may be used on coding projection regions with lower spherical sampling density, for example, where decreased values of Lagrangian multiplier may be applied. The SAD-based R-D cost implementation in (10), the SATD-based R-D cost implementation in (12), and the SSE-based R-D cost implementation in (13) should be modified as:

J_{SAD}=D_{SAD}+λ_{pred}^{(x, y)}·R_{pred} (28)

J_{SATD}=D_{SATD}+λ_{pred}^{(x, y)}·R_{pred} (29)

J_{SSE}=(D_{SSE}^{L}+w_{c}^{(x, y)}·D_{SSE}^{C})+λ_{L}^{(x, y)}·R_{mode} (30)

where λ_{pred}^{(x, y)}, λ_{L}^{(x, y)} and w_{c}^{(x, y)} may be the Lagrangian multipliers and the chroma weight parameter that may be applied to the current coding block located at the coordinate (x, y). The multipliers and/or parameters may be derived by substituting the adjusted QP values of the luma and chroma components (as indicated in (25) and (26)) into (8) and (9), as:

$$\begin{matrix}{λ}_{L}^{( x , y )} = α \cdot {ɛ}_{k} \cdot {2}^{\frac{Q {P}_{( x , y )} - 12}{3} ,} {λ}_{pred}^{( x , y )} = \sqrt{{λ}_{L}^{( x , y )}} & ( 31 ) \\ {w}_{c}^{( x , y )} = {2}^{\frac{Q {P}_{( x , y )} - Q {P}_{( x , y )}^{c}}{3}} & ( 32 )\end{matrix}$$

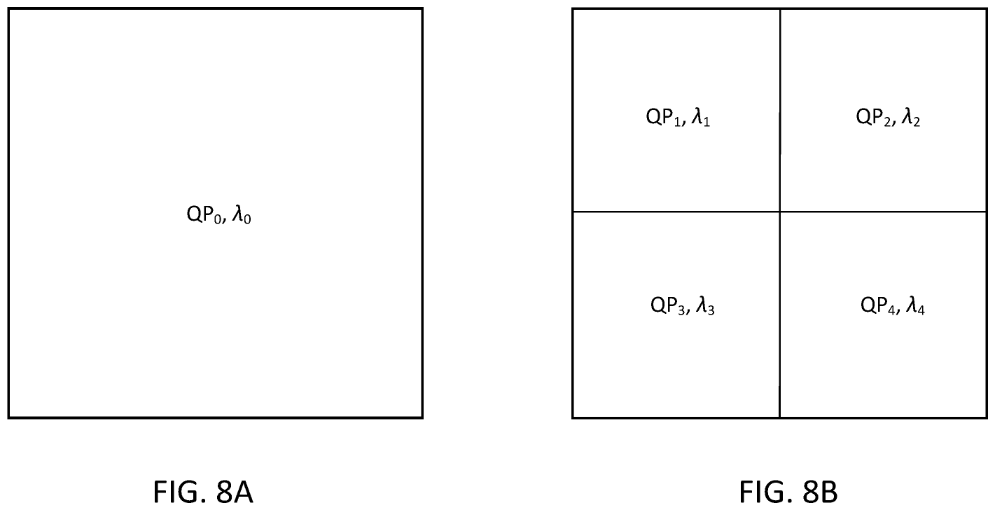

The value of the Lagrangian multipliers may be adjusted as in (31), and may be applied, for example, when the adaptation of the QP values is performed at a CTU-level such that the coding blocks (e.g., all the coding blocks) inside a CTU may use the same QP value and/or may be compared in terms of the rate-distortion (R-D) cost. The coding block that may be split or not split may be determined. As shown in FIG. 8, the R-D costs of the sub-blocks under the current coding block may be calculated based on different lambda values (e.g., λ₁, λ₂, λ₃ and λ₄ in FIG. 8), which may be different from the lambda value that may be used for the current block (e.g., λ₀ in FIG. 8). A weighted distortion calculation for the SSE-based R-D optimization may be performed when the adaptive QP adjustment is applied. For example, a weighting factor may be used for calculating the distortion of the current coding block at R-D optimization stage. If λ_{L}⁰ is the Lagrangian multiplier that is applied to the anchor block (e.g., the block associated with the input QP value QP₀), the SSE-based R-D cost implementation in (30) may be:

J_{SSE}=φ^{(x, y)}·(D_{SSE}^{L}+w_{c}^{(x, y)}·D_{SSE}^{C})+λ_{L}⁰·R_{mode} (33)

where φ^{(x, y)} may be the distortion weighting factor of the current block, which may further be derived as:

$${φ}^{( x , y )} = {2}^{\frac{Q {P}_{0} - QP ( x , y )}{3}} \qquad ( 34 )$$

The same Lagrangian multiplier may be used in the R-D cost calculation. For example, as shown in (33), as the same Lagrangian multiplier is used in the R-D cost calculation, the R-D costs of the blocks at various coding levels may be compared.

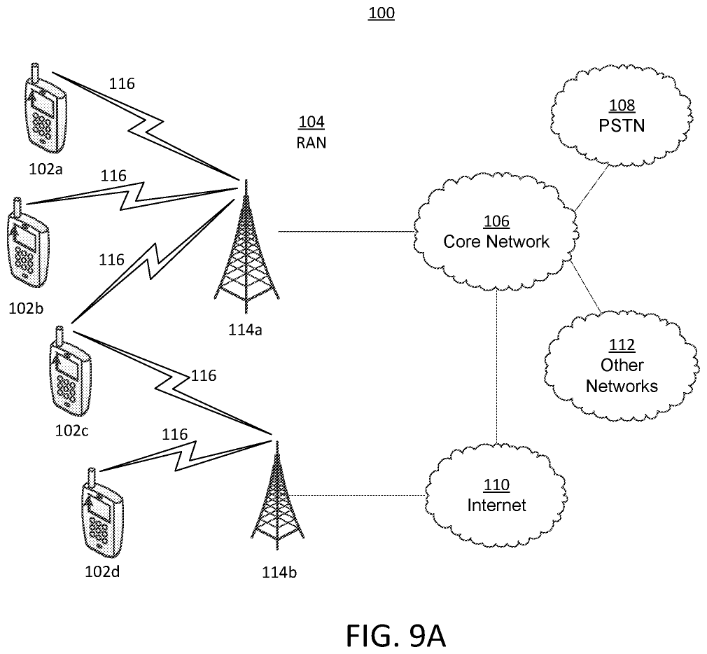

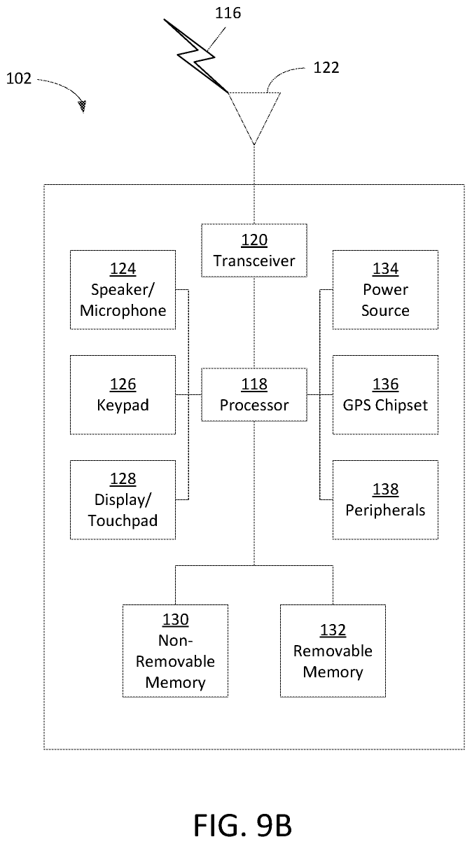

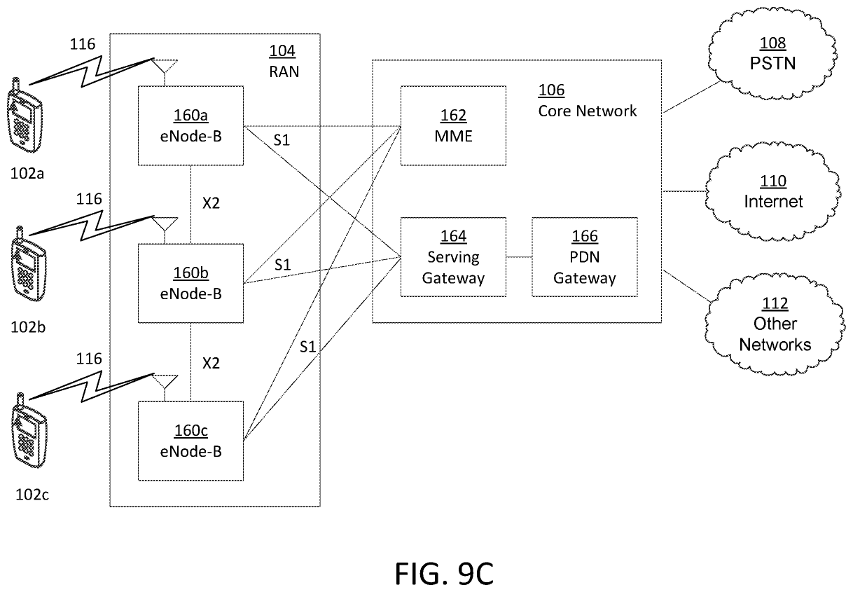

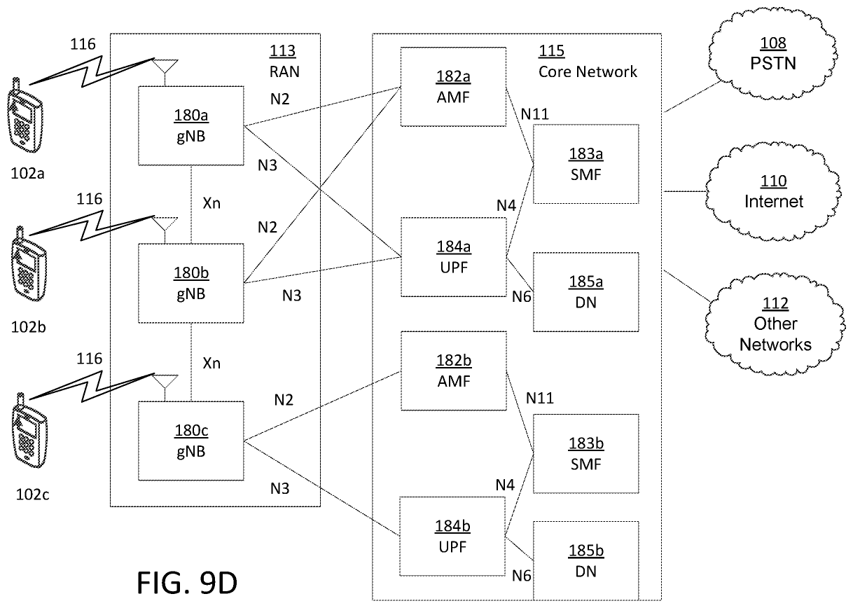

FIG. 9A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 9A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LIE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000. CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 9A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 9A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 9A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the Internet protocol (IP) in the TCP/IP Internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 9A may be configured to communicate with the base station 114a, which may employ a cellular-based radio technology, and with the base station 114b, which may employ an IEEE 802 radio technology.

FIG. 9B is a system diagram illustrating an example WTRU 102. As shown in FIG. 9B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 9B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 9B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 9C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 9C, the eNode-Bs 160a, 160b, 160c may communicate with one another over an X2 interface.

The CN 106 shown in FIG. 9C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 9A-9D as a wireless terminal, it is contemplated that in certain representative embodiments that such a terminal may use (e.g., temporarily or permanently) wired communication interfaces with the communication network.

In representative embodiments, the other network 112 may be a WLAN. A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 9D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing, other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 9D, the gNBs 180a, 180b, 180c may communicate with one another over an Xn interface.

The CN 115 shown in FIG. 9D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 9A-9D, and the corresponding description of FIGS. 9A-9D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the features and elements described herein consider LTE, LTE-A, New Radio (NR), and/or 5G specific protocols, it should be understood that the features and elements described herein are not restricted to LTE, LTE-A, New Radio (NR), and/or 5G specific protocols and may also be applicable to other wireless systems.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of decoding 360-degree video, comprising:
identifying a first luma quantization parameter (QP) associated with a first region;
determining, based on the first luma QP, a first chroma QP associated with the first region;
identifying a QP offset associated with a second region;
determining a second luma QP of the second region based on the first luma QP and the QP offset associated with the second region;
determining a second chroma QP of the second region based on the first chroma QP and the QP offset associated with the second region; and
performing an inverse quantization for the second region based on the second luma QP of the second region and the second chroma QP of the second region.

2. The method of claim 1, wherein the first region is an anchor coding block, the second region is a current coding block, and the QP offset associated with the second region is identified based on a spherical sampling density of the second region.

3. The method of claim 1, wherein the first region is a slice that comprises a current coding block or a picture that comprises the current coding block, the second region is the current coding block, and the QP offset associated with the second region is identified based on a spherical sampling density of the second region.

4. The method of claim 1, wherein the QP offset associated with the second region is identified based on a coordinate of the second region.

5. The method of claim 1, wherein the QP offset for the second region is identified based on a QP offset indication in a bitstream.

6. The method of claim 1, wherein the second luma QP and the second chroma QP are determined at a coding unit level or a coding tree unit level.

7. The method of claim 1, wherein the determining of the second chroma QP comprises:
determining a weighted QP offset by applying a weighting factor to the QP offset; and
determining the second chroma QP by applying the weighted QP offset to the first chroma QP.

8. The method of claim 7, further comprising:
receiving a chroma QP weighting factor indication in a bitstream; and
determining the weighting factor for the QP offset based on the received chroma QP weighting factor indication.

9. A device for decoding 360-degree video, comprising:
a processor configured to:
identify a first luma quantization parameter (QP) associated with a first region;
determine, based on the first luma QP, a first chroma QP associated with the first region;
identify a QP offset associated with a second region;
determine a second luma QP of the second region based on the first luma QP and the QP offset associated with the second region;
determine a second chroma QP of the second region based on the first chroma QP and the QP offset associated with the second region; and
perform an inverse quantization for the second region based on the second luma QP of the second region and the second chroma QP of the second region.

10. The device of claim 9, wherein the first region is an anchor coding block, the second region is a current coding block, and the processor is configured to identify the QP offset associated with the second region based on a spherical sampling density of the second region.

11. The device of claim 9, wherein the first region is a slice associated with a current coding block or a picture associated the current coding block, and the QP offset associated with the second region is identified based on a spherical sampling density of the second region.

12. The device of claim 9, wherein the second luma QP and the second chroma QP are determined at a coding unit level or a coding tree unit level.

13. The device of claim 9, wherein the QP offset associated with the second region is identified based on at least one of: a reception of the QP offset indication associated with the second region via a bitstream, or a coordinate of the second region.

14. The device of claim 9, wherein the processor is configured to determine the second chroma QP of the second region based on the QP offset being multiplied by a weighting factor.

15. The device of claim 9, wherein the determination of the second chroma QP comprises:
determining a weighted QP offset by applying a weighting factor to the QP offset; and
determining the second chroma QP by applying the weighted QP offset to the first chroma QP.
